(19) United States
(12) Patent Application Publication
(10) Pub. No.: US 2019/0208954 A1
(43) Pub. Date: Jul. 11, 2019

(54) Portable Device With a Temperature-Setting Element

(71) Applicants: Jacqueline Maria Martina van Dorp, Den Haag (NL); Luke Heiko Vos, Den Haag (NL); Mark Andrew Little, Birchington (GB)

(72) Inventors: Jacqueline Maria Martina van Dorp, Den Haag (NL); Luke Heiko Vos, Den Haag (NL); Mark Andrew Little, Birchington (GB)

(21) Appl. No.: 16/036,316

(22) Filed: Jul. 16, 2018

Related U.S. Application Data
(60) Provisional application No. 62/532,979, filed on Jul. 14, 2017.

(51) Int. Cl. A47J 36/24; H05B 3/80; H05B 3/50; H05B 1/02

(52) U.S. Cl. CPC A47J 36/2433; H05B 3/80; H05B 2203/021; H05B 1/0269; H05B 3/50

(57) ABSTRACT

A portable device having a temperature setting element is described. In some implementations, the portable device can include a cap including an integrated power source for supplying power; a housing including a storage for storing content; and a temperature-setting element including a temperature detection component for detecting the temperature of the content and a temperature-adjusting component for adjusting the temperature of the content. The temperature-setting element can include a core and one or more flanges protruding from the core. The temperature-setting element can receive power supplied by the integrated power source to perform the adjustment of the temperature of the content.

### CROSS REFERENCE TO RELATED APPLICATION

This application claims the benefit of priority to U.S. Provisional Application Ser. No. 61/236,531 titled “Portable Device Having a Temperature-Setting Element,” filed on Jul. 14, 2017, the disclosure of which is incorporated herein by reference in its entirety.

### TECHNICAL FIELD

The subject matter of this application is in the field of bottles, and more specifically to such bottles that aid in the preparation of bottle contents for general consumption.

### BACKGROUND

Milk is a food considered essential to many cultures and ways of life. Many people consume milk from animals, particularly cows. However, certain consumers can experience adverse reactions to bacteria, proteins, enzymes, and other components in raw, or even pasteurized, milk that has not been maintained or stored properly.

In the case of infants or babies, they are particularly vulnerable when milk is not maintained or stored according to the industry standards. Some newborn babies do not sleep through the whole night, needing to be fed at certain intervals. Many mothers breastfeed their infants. For those who do not have the capability to breastfeed their infants due to insufficient breast milk production or otherwise, they rely on bottle-feeding to provide the only food source to their babies.

### SUMMARY

Systems, devices, and methods for maintaining and storing contents in a bottle at a desired temperature are described.

The details of one or more implementations of the subject matter described herein are set forth in the accompanying drawings and the description below. Other features, objects, and advantages of the subject matter described herein will be apparent from the description and drawings, and from the claims.

### DESCRIPTION OF DRAWINGS

FIG. 1 shows a cap of a portable device having a temperature-setting mechanism.

FIG. 2A shows a schematic view of a portable device.

FIG. 2B shows a schematic view of a portable cleaning system configured for use with a portable device.

FIG. 3 shows an exploded view of a cap.

FIG. 4A shows a top view of a cap.

FIG. 4B shows a top view of a temperature-setting element.

FIG. 4C shows an internal temperature sensor connected to a temperature-setting element.

FIG. 5A shows a first implementation of a temperature-setting element used by a portable device.

FIG. 5B shows a second implementation of a temperature-setting element used by a portable device.

FIG. 5C shows a third implementation of a temperature-setting element used by a portable device.

FIG. 6 shows an internal structure of a cap.

FIG. 7 shows an electrical connection of a cap.

FIG. 8 shows the insertion of a cap into a portable housing of a portable device.

FIG. 9 shows the removal of a cap from a portable housing of a portable device.

FIG. 10 shows a diagram illustrating various energy and energy density of exemplary battery systems that can be used as an integrated power source.

Like reference symbols in the various drawings indicate like elements.

### DETAILED DESCRIPTION

### Overview

Bottle-feeding infants can be inconvenient to both mothers and caretakers. Before the infant can begin drinking milk or milk formula from the bottle, the contents must be correctly prepared. For example, the contents of the baby bottle must be maintained or stored at a correct temperature so as to be warm enough that it is drinkable but cannot be too hot that could potential scald or burn the baby.

Infants are generally fed with warm liquids such as warm milk because they are soothing and ideal for their developing stomachs and because such warm liquids can mimic the warmth of breast milk that is naturally warm. Heating infant formula or milk can take various form using, for example, a microwave, stove top, or placing the bottle in running warm water so that heat transfer between the warm water and bottle contents can occur. But all of these methods are time- and energy-inefficient.

For example, putting a baby bottle in warm water bath until the water bath is warm enough to warm the bottle contents can be time-consuming. It also takes time to gauge the temperature of the heated contents and to await the heated contents to settle to its desired temperature. As another example, heating a baby bottle in a microwave does not consistently warm a bottle because the heat transfer rate is dependent upon a bottle's physical structure and material and therefore is different from bottles to bottles. This results in inaccurate heating, requiring mothers and caretakers to reheat the bottle if it's not warm enough (which wastes electricity) or to cool it down if it's too hot (which wastes time). While there are bottles that facilitate warming the contents in the baby bottle, such devices are generally large in size and require an electrical socket to an electrical wall outlet to provide electrical power, making them undesirable for use or transport during travel.

Also, milk has the most stringent temperature requirements of any beverage due to bacterial content in the milk. If left out at room temperature it will spoil and after two hours should be discarded. Commercial transport of milk is required by law to maintain the temperature below 45° F./7° C.). However, once in the consumer's hands, they have no means of storing or transporting milk for longer than a short time of about two hours, without running the risk of spoilage due to harmful bacterial growth. This is a concern for mothers of small children during day time outings and also for children taking milk to school for their lunch.

Milk is one exemplary beverage for which the temperature really makes a difference in the taste. Even a few degrees can make a noticeable difference. Another example is coffee. One challenge in keeping milk cold (or coffee hot) is the fact that the specific heat of milk is 0.92 Btu, which means that 92 Btu will be needed to raise 100 lbs of milk by 1° F. The specific heat of water is 1 Btu. Thus if the surrounding temperature is room temperature, the temperature of milk will rise quicker than for the same volume of water. All of these factors increase the difficulty of keeping milk at a safe temperature.

At a high level, and as will be discussed in greater detail below, a portable device (e.g., a baby bottle) is described that provides continuous heating to content inside the portable device using a portable or removable temperature-setting element. In some implementations, the heating mass of the removable temperature-setting element can be die-casted out of aluminum, then a thermocouple cap of the portable device can be secured by O-ring and threaded to the device (or via a food grade glue/silicon). The electrical connections of the removable temperature-setting element can be over-molded or secured into place, for example, with a fastening mechanism or food grade glue/silicon. In some implementations, the top half of the removable temperature-setting element (e.g., which can be a food grade polymer shaft) can be manufactured using injection molding techniques. This can be made out of food grade PP, or if strength need to be increased, a food grade ABS. Food grade PET is also an option. In some implementations, the top half of the removable temperature-setting element can be attached to the cap. Optionally, ultrasonic welding or other melting-based techniques can be used to secure the polymer to the cap.

In some implementations, the portable device can include some or all of the following components (each of which will be described in greater detail in succeeding sections): an activation switch configured to activate or deactivate the portable device; a built-in or integrated power source (e.g., battery, li-ion, li-polymer, NiMH or any suitable battery); a first display configured for identifying the condition of the integrated power source (e.g., remaining power); a second display configured for displaying messages to the user such as “keep milk hot for X time” (e.g., keep milk warm at 37° C. or 98.6° F. two or three times); a printed circuit board with components (comprising integrated circuits, resistors, capacitors, heat safety circuits, etc.); a removable temperature-setting element (e.g., a positive temperature coefficient (PTC) or negative temperature coefficient (NTC) temperature-setting element) configured to heat or cool content; a release switch configured to releasing a temperature-setting element from some or all of the components of the portable device (e.g., cap and housing); battery charger connector for connecting to power source (wired or wirelessly); a removable temperature sensor (e.g., thermocouple) configured to detect and measure temperature; an electronic connector to power and communicate between the portable device and the temperature-setting element as well as the removable temperature sensor; a sealing ring (e.g., a silicone ring, though this is optional); a connector house (e.g., configured to connect between multiple bottles from various suppliers); a ring (e.g., a double O-ring) configured to provide a waterproof connection; a heat sink to reduce heat to allow “extraneous” heat to dissipate away from the portable device to protect the user and the device); a mechanical locking device configured to keep the housing in place and connected to the electronic connector; a transport system configured to keep the portable device clean during transport before and after use; and aluminum and anti-burn ceramic coating on some or all of the components described above (to allow the portable device to be cleaned with ease and to prevent milk from overheating); and one or more fins or flanges that can serve as an addition to or in lieu of the temperature-setting element, heat sink, or temperature sensor described above. Each flange can include its own electrical circuitry to provide temperature-setting functions, temperature-sensing function, or power dissipation function. Alternatively, some of the flanges can share circuitry such that these flanges carry out the same functionality (e.g., temperature-setting, temperature-sensing, or heat sink).

The application of the subject matter described herein is not limited to the transportation and storage of milk. Other examples may include adults who wish to take smoothies, iced tea, coffee, hot tea, other beverages or food in a portable container.

### System and Device Overview

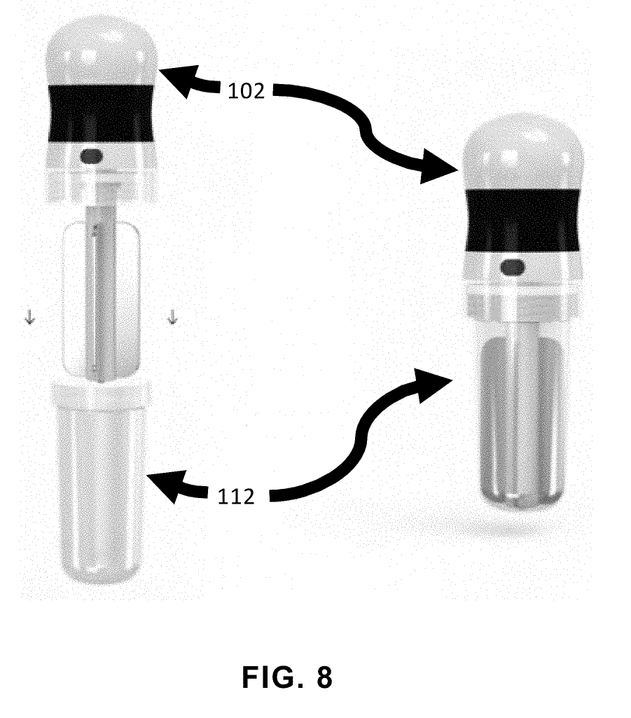

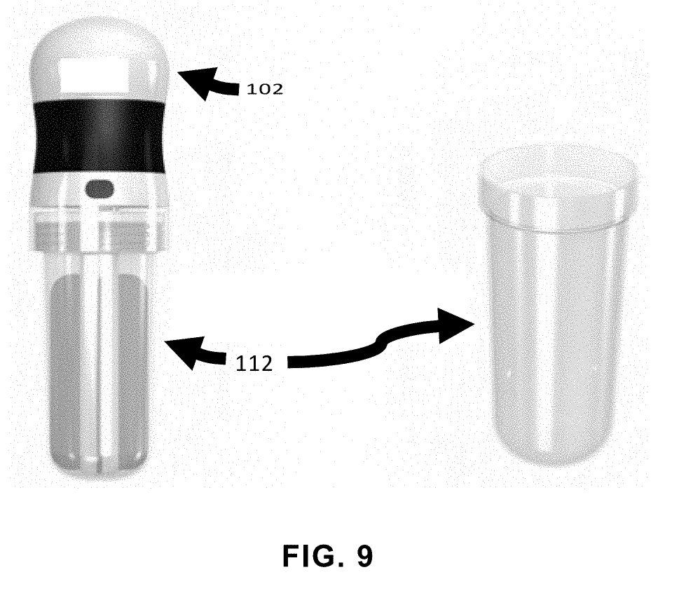

As will be described in great detail below, a portable device 100 with a temperature-setting element is provided. The portable device 100 allows content (e.g., milk) to be heated to 37° C./98.6° F. In some implementations, this temperature can be a user-customized temperature (e.g., set by a user via a signal indicator described below or via a user interface or display on the portable device 100). The portable device 100, in some implementations, can include a cap 102 and a portable housing 112 where the cap 102 can be inserted onto the portable housing 112 (see, e.g., FIG. 8 shows the insertion of the cap 102 into the portable housing 112 of the portable device 100, and FIG. 9 shows the removal of the cap 102 from the portable housing 112 of the portable device 100).

The portable housing 112 of the portable device 100 can be made using Acrylonitrile Butadiene Styrene (“ABS”) through, for example, an injection molding process. ABS resins as thermoplastic polymers can be used for the portable device 100 because of the light weight, good molding processability, excellent mechanical properties such as high tensile strength and high impact strength, and superior thermal properties such as high coefficient of thermal expansion and high heat distortion temperature. Other materials such as polyvinyl chloride, polyethylene terephthalate, polycarbonate, polyimide, liquid crystal polymer, polyetherimide, polyphenylene sulfide, polysulfone, polystyrene, glycol-modified polyester, polypropylene, any bio-degradable polymer composite material, or any desired combination thereof also are contemplated.

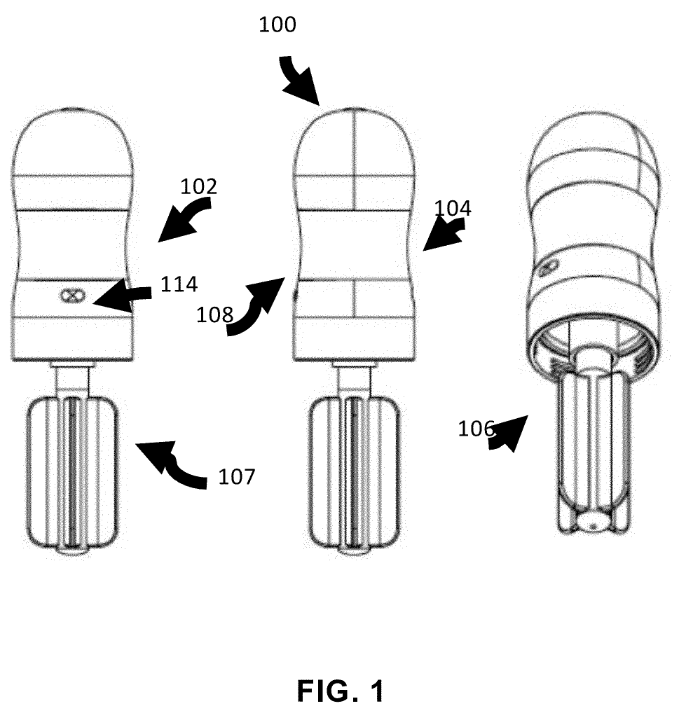

Referring to FIG. 1, a portable device 100 showing an upper portion is illustrated. The upper portion includes a top portion 102, a middle portion 104, and a bottom portion 106. In some implementation, the top portion can include a cap 108 and the cap 108 can include a quick release mechanism 114 that allows the internal components (e.g., those that connect to the cap or the removable temperature-setting element described below) to be released from the portable device 100 so that these components can be replaced, washed, cleaned, and maintained. The quick release mechanism 114 can also be configured to release the top portion 102, the middle portion 104, and the bottom portion 106, or a combination thereof from each other so that they can be separated or maintained separately.

The middle portion 104 can include additional components for connecting the upper portion to the bottom portion 106 of the portable device 100. The bottom portion 106 of the portable device 100 can include a temperature-setting element 107 connected thereto for heating or cooling content inside the portable housing 112. As will be discussed in greater detail below, each of the top portion 102, middle portion 104, and bottom portion 106 can be structurally separated or released so that they can be maintained or cleaned (e.g., washable and sterilisable) separately from other components.

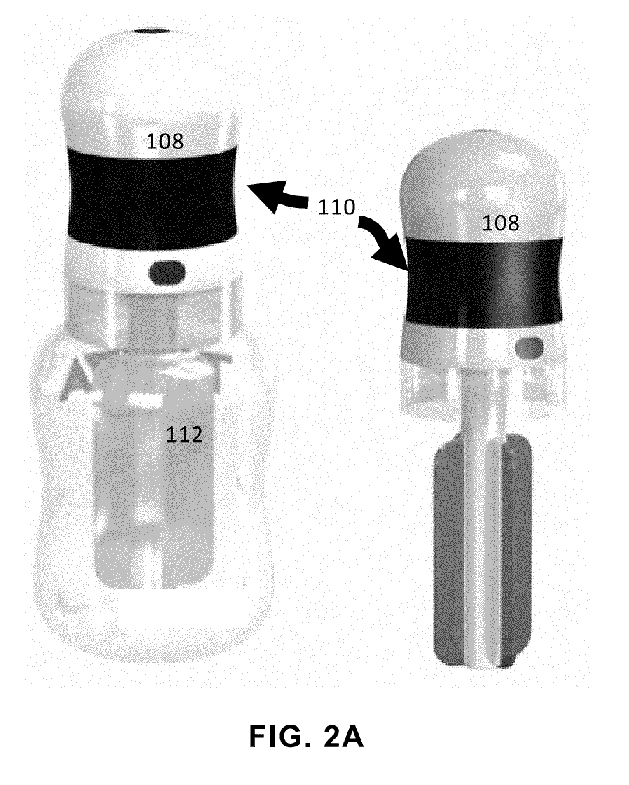

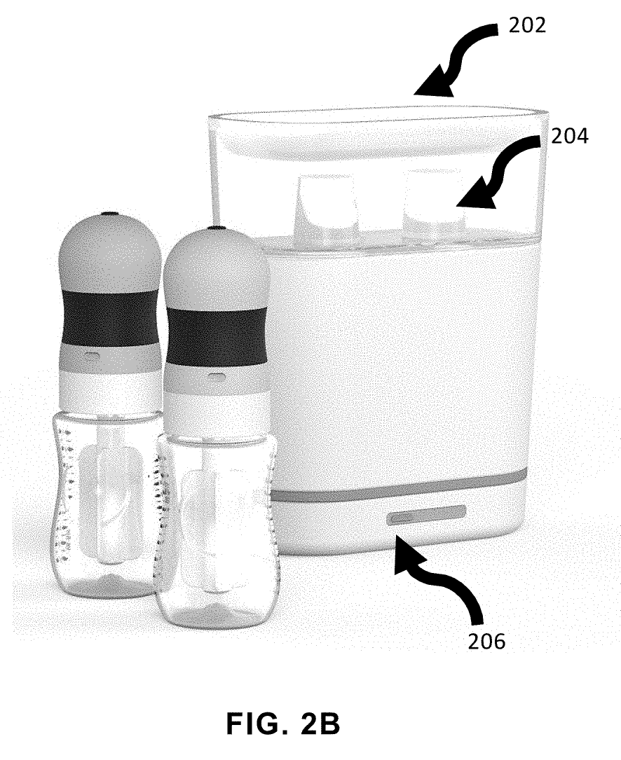

FIG. 2A shows a schematic view of the portable device shown in FIG. 1. Referring to FIG. 1, in some implementations, the cap 108 can include a grip portion 110 that facilitates the manual handling of the portable device 100. The grip portion 110 can include an anti-slip structure that provides superior handling of the portable device 100 by a user. The anti-slip structure, in some implementations, can include a thermoplastic elastomer layer made from a composite material that comprises a soft-segment plastic material blended with a hard-segment plastic material. The composite material can be, for example, thermoplastic elastomer (TPE) that combines the characteristics of rubber and plastic.

During fabrication of the TPE, soft-segment plastic (e.g., rubber) and hard-segment plastic (e.g., plastics) can be blended. When heating the blended materials to a specific temperature, the soft-segment plastic and the hard-segment plastic can be melted, forming the elastomer. Under room temperature, the soft-segment plastic is elastic, and the hard-segment plastic plays the role of preventing plastic deformation. The soft-segment plastic can be selected from the group of polyvinyl chloride (PVC), polyethylene-butene, nitrile butadiene rubber (NBR), styrene-butadiene rubber (SBR), styrene ethylene butylene styrene rubber (SEBS), thermoplastic polyolefin (TPO), thermoplastic rubber (TPR), ethylene vinyl acetate (EVA), polyethylene (PE), and acrylic. The hard-segment plastic can be selected from the group of polyethylene, polystyrene, polypropylene, polyurethane, polyesters and polyamides.

FIG. 2B shows a schematic view of a portable cleaning system 202 configured for use with a portable device (e.g., the portable device 100). The portable cleaning system 202 can be used to maintain the cleanliness of the portable device. For example, the housing 107 can be removed from the portable device 100 and placed onto the cleaning modules 204. Once the portable cleaning system 202 is activated (e.g., by activating the switch 206), the portable cleaning system 202 can release detergent and water to wash and sterilize the housing 107. Although this example is described with respect to the housing 107, the portable cleaning system 202 can be configured to clean or maintain any part or component of the portable device 100 without any physical damages to such part or component.

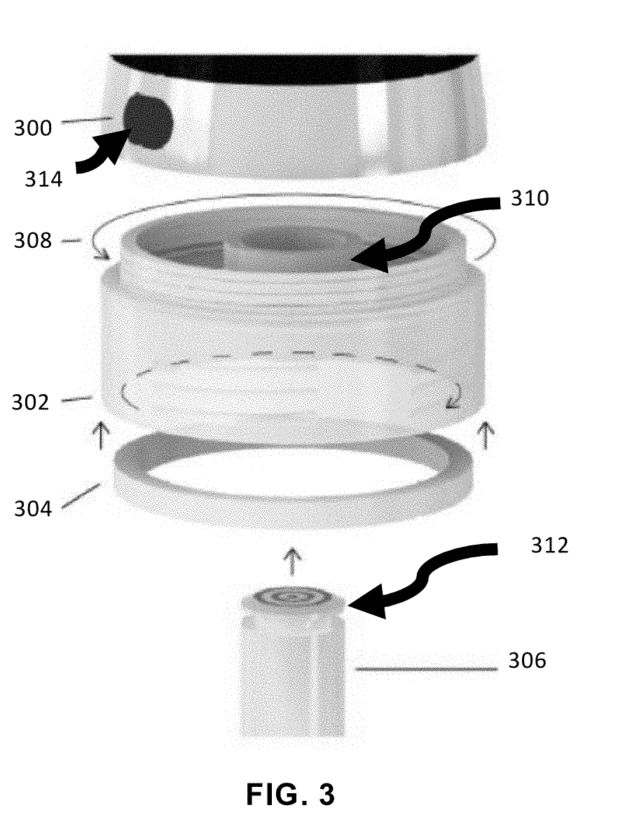

FIG. 3 shows an exploded view of a cap. Referring to FIG.3, the cap 300 can be connected to a temperature-setting element 306 via a first connecting portion 302 and a second connecting portion 304. The first connecting portion 302 can connect the cap 300 to the second connecting portion 304, and the second connecting portion 304 can connect the first connecting portion 302 to the portable housing 112.

In some implementations, the first connecting portion 302 can include a channel 310 through which the temperature-setting element 306 can pass through so that it can be locked or secured to the portable device via the locking mechanism 312. In some implementations, the opening of the channel 310 includes a seal (not shown) to prevent water from sipping into the area in which the integrated power source is located. In some implementations, the seal can lay on top of the opening such that the locking mechanism 312 (described below) is in between the seal and the opening of the channel 310. The water-tight seal can be made with flexible material such that when the temperature-setting element 306 is released (e.g., by the quick release mechanism (described below), the seal will cover the opening of the channel to provide additional waterproof ability of the portable device and protect sensitivity electronic hardware inside the cap or first connecting portion 302.

In some implementations, the cap 300 and the temperature-setting element 306 can be removed and replaced with an assembly (not shown) to facilitate the consumption of the content inside the house. In some implementations, the assembly can include a nipple. The nipple can help to simulate the nursing experience. When the nipple is not in use, the nipple can be covered with a bottle cap to maintain hygiene of the nipple. The nipple can include a threaded collar that can engage the first connecting portion 302. The collar can be internally threaded. The internal thread of the collar can be configured to receive the threaded portion of the first connecting portion 302. The nipple can include a groove. A portion of the collar can be held within the groove. The assembly can include a tube that connects from the nipple to the opening of the opening 310. For example, a proximate end of the tube can couple through a hollow protrusion extending away from the nipple and into the housing. The hollow protrusion can be a hollow cylindrical protrusion. To consume the content, the nipple can be used to draw the content out of the housing through the tube.

The nipple can be manufactured from a flexible, durable material that is dishwasher safe and heat resistant, such as silicone. The cover can be manufactured from a rigid, durable, transparent material that is dishwasher safe and heat resistant, such as plastic.

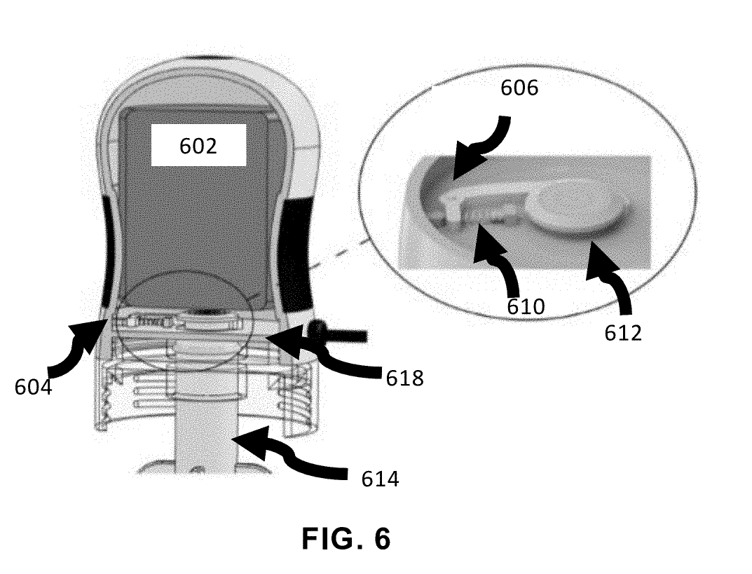

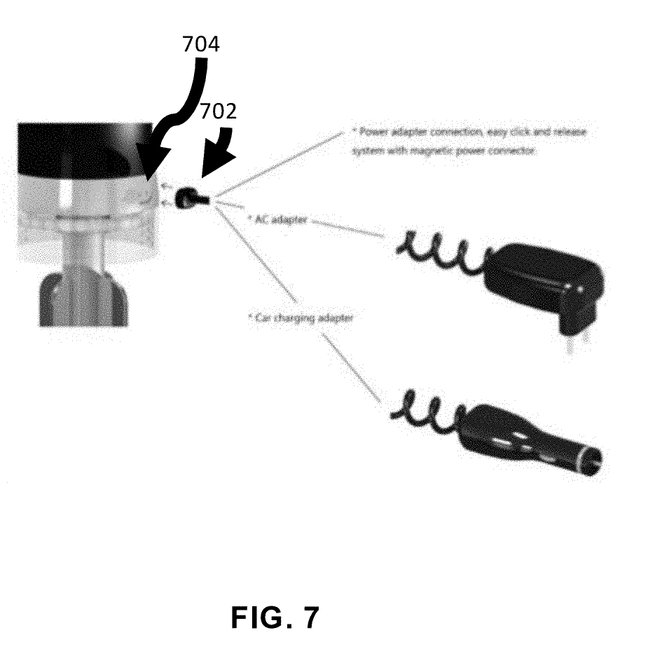

In some implementations, the temperature-setting element 306 can be displaced from the portable device 100 by activating the quick release mechanism 314. For example, by activating the quick release mechanism 314, the locking mechanism 312 can be released from the portable device 100. For example, as shown in FIG. 6, upon activating the quick release mechanism 604, which pushes the spring mechanism 610 inwards to unlatch the latch mechanism 606 from the locking mechanism 612 to release the core 614. In some implementations, the quick release mechanism 314 can also be used to release the temperature sensor from the temperature-setting element.

In some implementations, instead of the spring mechanism 610 and the latch mechanism 606, the portable device can include a magnetic-based mechanism. In these implementations, the quick release mechanism 604 can include a magnetized mechanism to keep the locking mechanism 612 in place (e.g., via a small analog magnet). When the quick release mechanism 604 is activated, it de-magnetizes the magnetized mechanism to release the locking mechanism 612 from the portable device 100.

One advantage to allowing the temperature sensor and the temperature-setting element to be removable from the portable device is that it allows only those damaged components (e.g., components damaged by heat) to be replaced so that the portable device remains functional or operational without subjecting the entire portable device to be disposed, which could increase the overall costs to the user.

Another advantage of the portable device described herein is that allowing each flange (e.g., flanges 504-510) to be removable and replaceable with other flanges having particular functionalities reduces circuit complexity while allowing unique component customization to accommodate special user cases in which the temperature need be increased or decreased beyond the room temperature. Because the portable device can include one or more controllers to configure functionalities of these components, the portable device can readily be adaptable to particular usage specific to a user.

In some implementations, the second connecting portion 304 can include a ring 308 (e.g., an O-ring) to allow for a water tight connection between the cap 300 and the portable housing 112. To provide for water-right connection, in some implementations, the ring 308 can be made of silicon to provide for waterproof connection between the first connecting portion 302, the second connecting portion 304, the temperature-setting element 306, and the portable housing 112. The second connecting portion 304 can be made of food grade material, such as stainless steel, silicone, and polytetrafluoroethene (PTFE), high-Density polyethylene (HDPE), polyethylene Terephthalate (PETG), polyethylene (PE) or polypropylene (PP). Other material such as non-metallic material such as non-zinc or non-brass alloyed material also can be used.

In some implementations, the ring 308 can include grooves to allow for, for example, twistable connection or other types of connection to the cap 300. In some implementations, the ring 308 can be integrated with the first connecting portion 302. In some implementations, the ring 308 can be integrated with the cap 300. In these implementations, the cap 300 can serve to connect with the first connecting portion 302.

### Temperature Sensor

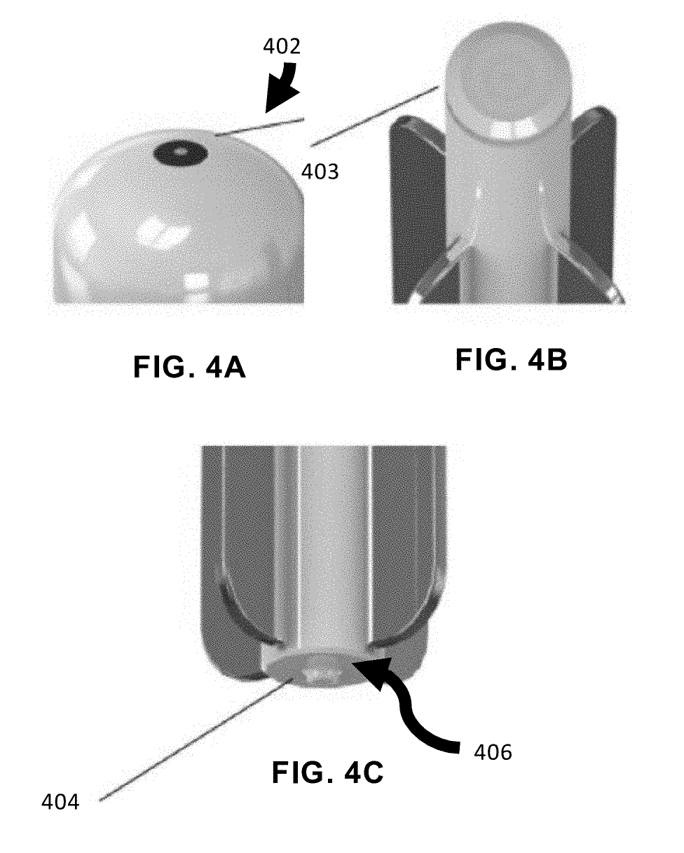

In some implementations, the portable device 100 can include a removable temperature sensor coupled to the temperature-setting element 306 to detect the temperature of the content inside the housing 107. FIG. 4C shows an example of a temperature sensor.

As shown in FIG. 4C, the temperature sensor 404 can be a thermocouple or thermistor, physically attached and thermally coupled to the temperature-setting element 406. Alternatively, a thermocouple, thermistor, non-thermocouple, or other temperature sensor, may be disposed within the bottom portion 106 of the portable device 100 to sense the ambient temperature or temperature of the content stored in the housing 112.

The temperature sensor 404 can utilize various temperature measurement techniques to sense and measure the temperature of locations within the housing 112. For example, the temperature sensor 404 can be an infrared (IR) temperature sensor that uses infrared to measure temperature. In other examples, as alternatives to infrared sensing, the temperature sensor 404 may utilize phosphor thermometry or pressure measurements to sense the temperature of the content. The temperature sensor 404 can be directed, positioned, or otherwise oriented toward a specific angle or portion of the portable device 100 to sense the temperature at that particular portion. In some implementations, the temperature sensor 404 can be oriented to sense a temperature of a particular surface or content inside the housing 112.

Since the content inside the housing 112 can have varying temperatures due to different components, materials, and/or dimensions of the housing, in some implementations, the temperature sensor 404 can use multiple temperature sensors (e.g., by having one or more flanges 504) to identify these different temperatures instead of sensing a single general temperature of the content. In some implementations, based on the sensed temperature, the temperature-setting element can include a heat pipe, light pipe, or other energy transfer element that conducts energy from a desired surface to the content or to the location of the temperature sensor 404.

In some implementations, the temperature sensor 404 can include a phase change material configured to reduce temperature variations and provide a single surface for the temperature sensor 404 to sense the temperature.

In addition to providing temperature measurements of specific locations within the housing 112, the temperature sensor 404 can reduce manufacturing complexity. For example, one or more temperature sensors can be mounted to a printed circuit board or hybrid board and oriented towards the desired surface (e.g., a surface of the housing 112) for temperature measurement.

For example, two temperature sensors can be used and oriented in a way to sense temperature of different surfaces and/or components within the housing 112. A first temperature sensor (e.g., flange 504) can be configured to sense a first area within the housing 112 and a second temperature sensor (e.g., flange 510) can be configured to sense a second area within the housing 112. As another example, the first area within the housing 112 can be one housing surface within the housing 112, and the second area within the housing 112 can be another housing surface within the housing 112. Since temperatures within the housing can be non-uniform depending on where the temperature is detected, e.g., due to thermal transfer within the housing 112 or other external factors, more than two temperature sensors can be used to identify temperature variations or “hot spots.” In some cases, a one or multi-dimension array of temperature sensors can be provided to sense one or more areas within the housing 112.

In some implementations, two surfaces being sensed for temperature can be located adjacent to one another (e.g., different locations of a generally planar surface). In this example, the temperature sensors can be mounted to the same side of the core 403 and oriented toward their respective surfaces. In other examples, the two surfaces can be generally opposed to one another (e.g., surfaces separated by a hybrid board carrying each of the temperature sensors). In this example, each temperature sensor can be mounted on opposing sides of the core 403 such that one sensor senses temperature on one side of the core 403 and the other sensor senses temperature on the opposite side off the core 403. Each temperature sensor can sense temperatures simultaneously (or at different times) such that temperature sensor 404 can process multiple temperatures at the same time. Alternatively, one or more temperature sensors can be selectively enabled by one or more controllers or processors.

This selective temperature sensing can reduce power consumption from unnecessary temperature sensors. In addition, selective temperature sensing can reduce power consumption and/or processing speed needed to process signals from unneeded temperature sensors. In one implementation, each of the temperature sensors can include a flange that opens to detect energy and closes to prevent energy detection. For example, the controller can select to sense the temperature of a first area within the housing 112 with a first temperature sensor instead of a second area within the housing 112 with a second temperature sensor. Responsive to the selection, the controller can control a first flange (e.g., flange 506) of the temperature-setting element to open and control a second flange (e.g., flange 510) of the temperature-setting element to close. Alternatively or additionally, the controller can selectively send power to desired temperature sensors to sense the temperature of a portion of the content inside the housing. In some implementations, where the temperature sensor has more than one flange, at least one flange can be used as a heat sink (e.g., flange 508) to dissipate heat radiated from the temperature-setting element to avoid damage to the temperature-setting element or the portable device. In some implementations, all flanges can be used as a heat sink to provide additional heat protection to the portable device. In some implementations, when some or all of the flanges are used as a heat sink, these flanges act to increase the surface area of the temperature-setting element, which allow content inside the housing to be heated or cooler quicker and with more efficiency than with just the temperature-setting element by itself. This is advantageous because it conserves the integrated power source (e.g., by radiating more power through a larger surface area without increasing power consumption), and in turns, prolongs the charge capacity of the integrated power source to heat (or cool) more content and bottles without recharging.

In some implementations, the one or more controllers or processors can reside in a printed circuit board (“PCB”), which can reside inside the core 403 to facilitate the control of the temperature-setting element to adjust the temperature and the temperature sensor to detect temperature from different areas inside the housing. In some implementations, the PCB can reside in the cap 300 in the vicinity of the battery (e.g., PCB 618 shown in FIG. 6).

The temperature sensor 404 can be used to provide temperature feedback for controlling the charging of the integrated power source to effect the energy transfer conducted by the temperature-setting element. For example, the temperature sensor 404 can monitor one or more temperatures to control charging and effectively limit temperatures of the temperature-setting element to provide a temperature-setting element with adjustable temperature. For example, the temperature sensor 404 can include one or more controllers (to be discussed below) to receive the temperature measurement and increase or decrease the power so that the temperature-setting element can radiate at a desired temperature to heat or cool the temperature of the content inside the housing 112. In some implementations, the one or more controllers can compare the sensed temperature to a fault condition threshold and disconnect the temperature-setting element from the integrated power source when the sensed temperature exceeds the fault condition threshold. In so doing, the content is not inadvertently overheat and potentially creates a safety hazard to the user (e.g., burned lips or tongues).

### Integrated Power Source

In some implementations, the portable device can include an integrated power source 602 (e.g., a battery pack) to provide power to the temperature-setting element. Referring to FIG. 6, an internal structure of a cap is shown.

As shown in FIG. 6, the integrated power source 602, in some implementations, can include enough charge capacity to allow up to three portable devices to be heated and maintained, for example, at 37° C./98.6° F. without a single re-charge. If a recharge is needed, a user can manually replace the power source with another fully-charged power source. The integrated power source 602 can advantageously supply power to the temperature-setting element for a prolonged period of time before the power charge diminishes, thereby advantageously maintaining the temperature of the contents of the portable device 100 while the contents are still hot or cold, for a prolonged period of time. In some implementations, the integrated power source 602 can power the temperature-setting element for an hour. In some implementations, the integrated power source 602 can power the temperature-setting element for greater than an hour.

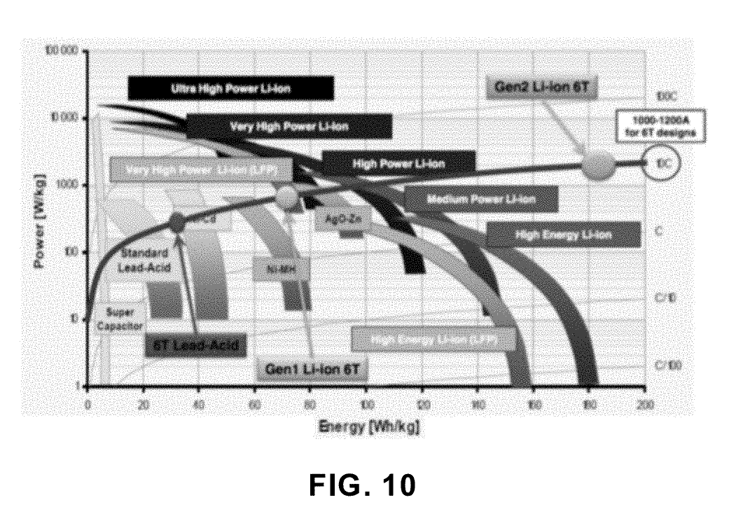

The integrated power source 602 can include one or more battery packs, such as rechargeable batteries. In some implementations, the battery can be provided in combination with a step-up transformer to provide the required power to the temperature-setting element. In some implementations, the integrated power source 602 can include one or more capacitors for storing power to be used to power the temperature-setting element. The integrated power source 602 can be electrically connected to the temperature-setting element and configured to supply power to the temperature-setting element to heat or cool at least a portion of the portable device 100.

Where the integrated power source 602 includes a battery pack, the battery pack can include one or more nickel metal hydride (“NiMH) batteries (e.g., with a nominal capacity of 1.7 Ah). Other batteries such as lithium polymer (Li-Po) batteries, nickel cadmium batteries, lithium-ion batteries, lead acid, or the like also are contemplated and their use is dependent on a specific application for which the portable device 100 is designed. FIG. 10 shows a diagram showing various energy and energy density of exemplary battery systems that can be used as the integrated power source 602.

For example, Li-Po batteries are made of carbon and highly reactive lithium, which can store a lot of energy. They are generally lighter and smaller in dimension and not limited in the shape or size as compared to NiMH batteries. Li-Po batteries also have higher capacities and voltages (e.g., 7.4V, 11.1V, 14.8V, and 22.2V) that can allow for more speed and power to allow for faster heating time. Because Li-Po batteries discharge energy at a different and flatter rate which is what allows them to have more power, Li-Po batteries are desirable where the application requires a consistent stream of energy to the temperature-setting element. But Li-Po batteries are generally more dangerous. If not stored properly, Li-Po batteries can create unexpected fire hazard. Also, Li-Po batteries have a shorter life span, which would require them to be replaced sooner than NiMH batteries.

NiMH batteries, on the other hand, use hydrogen to store energy, with nickel and another metal such as titanium acting as a lid on the hydrogen ions. Generally, NiMH batteries have a longer shelf life and endure more charging cycles. They are also cheaper to produce than Li-Po batteries and not likely to catch fire if damaged or punctured. But NiMH batteries are generally heavier and have a lower operating voltage range (e.g., 3.6V and 7.2V).

In some implementations, the integrated power source 602 can include a battery pack that has a volume of 56 cm³, but can be upgraded to a volume of 82 cm³. In some implementations, the integrated power source 602 can also include sufficient power source to charge the portable device 100 six times. For example, at 11.1V and 80 watts, the integrated power source 602 yields 7.2 amps, which translates into 40 W at 3600 mAh @1.1V for 1 hour of heating. Assuming a 5% energy loss, the integrated power source 602 yields 38 W, which provides for 27 minutes of non-stop heating.

Of course, other power levels and ranges can be selected for use, with such levels falling either within the above-described range or outside of this range. For instance, a low power level may be much lower than 40 W. These values described herein are merely examples, and other examples can include higher or lower values in accordance with the techniques described herein.

The integrated power source 602, in some implementations, can be a rechargeable power source, which can include, without limitations, one or more capacitors, batteries, or components (e.g. chemical or electrical energy storage devices). In other words, the integrated power source 602 can be replenished, refilled, or otherwise capable of increasing the amount of energy stored after energy has been depleted. The integrated power source 602 can be subjected to numerous discharge and recharge cycles (e.g., hundreds or even thousands of cycles) over the life of the integrated power source 602. The integrated power source 602 can be recharged when fully depleted or partially depleted.

In some implementations, as shown in FIG. 7 (which illustrates an electrical connection of a cap), the cap 300 can include a power receiver 704 configured to connect with a wireless power connector 702 so that the integrated power source can be charged via conventional means such as car chargers, AD adapters, or USB chargers. The power receiver 704 can be configured to accept and provide wireless charging (e.g., via a wireless charging station) in addition to wired charging. In these implementations, the power receiver 704 can be electrically connected to the integrated power source 602 that in turn are electrically connected to the temperature-setting element. In some implementations, the portable device is not plugged into a wall outlet; instead, it draws its power through the independent integrated power source. In doing so, the portable device can be transported with ease while still allowing the portable device to be used during transport.

In some implementations, the portable device can also include a charging circuit for charging the integrated power source 602 via power supplied by either the power receiver 704 or power connector 702. In these implementations, the charging circuit can monitor cell balancing of the integrated power source 602 during operation, as well as the discharge or power dissipation rate of the integrated power source 602. The charging circuit can also monitor the integrated power source 602 to determine if the shelf life of the integrated power source 602 is close to an end and whether the battery is unsafe. If the shelf life of the integrated power source 602 is close to an end or that the battery is unsafe that would require replacement, the portable device can display a signal to the user (e.g., via a signal indicator 402 on the cap 300 shown in FIG. 4A). In some implementations, the signal indicator 402 can be depressible and act as a switch for turning on and off the portable device 100.

In some implementations, the signal can be graphically displayed using one or more colors (e.g., red) to indicate that the integrated power source 602 needs to be removed and replaced with a new one. Although a visual indicator has been described, an audio indicator or a visual audio indicator can also be used to provide the signal indication to the user.

In some implementations, the power receiver 704 is completely disposed in the cap 300 so that no part of the receiver is visible in plain view. The power receiver 704 can be configured to receive power from an inductive coupling wireless power transmitter in a charging base or a charging pad. The wireless power transmitter can be electrically connected to a power source such as a wall outlet via a power cord.

During operation, if wireless charging is used and if the portable device 100 is out of range of the wireless power transmission, the integrated power source 602 can lose power and shut off. For example, if the portable device 100 is not near a wireless charging transmitter or out of the range of power transmission from a remote wireless charging transmitter, the temperature-setting element in the cap 300 will lose power and shut off. In some implementations, the portable device 100 can switch to battery power (e.g., via the controller to be discussed below) when the portable device 100 is out of range of power transmission from the remote wireless power transmitter so that the temperature-setting element can continue to heat or cool the contents of the portable device 100 for a period of time.

### Wireless Charging

As discussed above, the integrated power source 602 may be wirelessly charged. In these implementations, the integrated power source 602 can include, without limitation, a wireless charging mechanism (not shown) to facilitate wireless charging. The wireless charging mechanism can include a battery module, a signal receiving unit, a signal controlling unit, a cover, and a housing. The signal receiving unit and the signal controlling unit can be located at opposite sides of the battery module respectively. The cover can be used to engage with the battery module to make the signal controlling unit be received in a space between the battery module and the cover. The housing can house the battery module, the signal receiving unit, the signal controlling unit, and the cover therein. In some implementations, the battery module can be substantially rectangular and can include a frame and an energy storage received in the frame. A circuit can be mounted on a top end of the frame and can be coupled with the energy storage. A plurality of ports can be formed on a top side of the circuit to contact with the integrated power source 602.

In some implementations, the energy storage can store electric energy from external power source. The energy storage can also exchange the electric energy with the integrated power source 602 through a plurality of the leads or ports. The plurality of ports can be used to recharge the battery module, and also can be used to output the electric energy of the energy storage to the integrated power source 602 coupled to the plurality of ports.

The signal receiving unit can include a wireless receiver (e.g., similar to the wireless power receiver discussed above). The signal receiving unit can be fixed to a side of the battery module by gules or by a way of magnetic adsorption. The signal controlling unit can be located opposite to the signal receiving unit and is adjacent to a circuit. The signal controlling unit can be coupled with this circuit and used to exchange and modulate induced currents from the signal receiving unit and conduct the induced currents to the battery module through the circuit.

In some implementations, the wireless charging battery is not limited to wireless charging and also can be wire-charged.

### Signal Indicator

As discussed above, the integrated power source 602 can include a signal indicator 402 (see, e.g., FIG. 4A). In some implementations, the signal indicator 402 can also be configured to indicate the amount of power remaining and/or whether the integrated power source 602 is being charged. In some implementations, based on whether the signal indicator 402 is emitting light, a user can determine the operation state of the portable device 100, such as whether the portable device 100 is operating, the energy transmitting strength between the integrated power device 602 and the wireless charging battery.

In some implementations, the user can determine whether the wireless charging battery is normally operating based on whether the signal indicator 402 is emitting light. In some implementations, when the wireless charging battery continuously supplies power, the signal indicator 402 intermittently emits light; when the electricity transforming rate of the wireless charging battery is lower than a preset value, the signal indicator 402 continuously emits light.

In some implementations, the wireless charging battery can also include a switch. When the user activates the switch, wireless charging can be activated. Conversely, when the user deactivates the switch, wireless charging can be deactivated and wire-charging can be resumed.

In some implementations, the indicator can be a visual display configured to, for example, display the operation state or status of the wireless charging battery (e.g., as will be discussed above in the User Interface section).

One advantage of providing wireless charging is to facilitate the transport of the portable device 100 while on the road. Because wired charging stations or wall plugs are not always available, a portable device implemented with wireless charging capability can allow a user the flexibility to use the device while traveling and without any concern for wired connections.

### Controller

In some implementations, the portable device can include one or more controllers, such as a microcomputer provided with suitable software, for controlling and managing the signal indicator 402 (or the display or user interface described herein), temperature-setting, temperature-sensing, and heat dissipation of the temperature-setting element. In some implementations, the controller can also control and manage the content's temperature sensed or detected by the temperature sensor 404 (see, e.g., FIGS. 4B and 4C). In some implementations, the controller can be used to record the temperature of the content at various intervals, identify and display the time elapsed since the last heating or cooling, display the amount of power left, and indicate (e.g., via the signal indicator 402) the amount of time that the temperature-setting element can remain operational based on the current amount of power or battery left in the integrated power source 602. In some implementations, the controller resides inside the cap 300 (e.g., mounted on the PCB described above). Based on the temperature detected, the controller can adjust the temperature-setting element or heat sink. The controller also can be configured to adjust the configurations of the flanges 504-510 so that one or more of such flanges can perform temperature-setting functions, temperature-sensing functions, heat sink functions, or a combination thereof. In some implementations, the controller and the PCB can reside inside the core 403 next to the temperature-setting element.

In some implementations, the controller can communicate with the charging circuit to monitor the charging level of the integrated power source 602 to ensure that the integrated power source 602 is not overcharged and can discontinue the charging process once the integrated power source 602 has reached its full capacity in order to maximize the shelf life of the integrated power source 602. In some implementations, the controller can also detect that the battery level of the integrated power source 602 has decreased over time and dropped to a predetermined threshold such that charging is needed. In these implementations, the controller can control the signal indicator 402 to alert the user that charging is needed.

In some implementations, the controller can communicate with the temperature sensor to detect the temperature of the content on a programmable or continuous basis. In these implementations, the controller can pool the temperature sensor for information about the temperature of the content, and if necessary, generates and sends instructions for the temperature-setting element 107 to increase or decrease the temperature of the temperature-setting element 107.

### User Interface

In some implementations, the portable device can include a display controlled by the controller to indicate user-specific information, including, for example, the time elapsed since the last heating or cooling, the amount of power left in the integrated power source 602, a number of times that the portable device is used to set the temperature without being charged (e.g., the portable device has enough power to heat (or cool) the content three times at a predetermined temperature without being charged), and the amount of time that the temperature-setting element can remain operational based on the current amount of power remaining in the integrated power source 602.

In some implementations, the display can be a touch-screen display. This display can, in some implementations, function as the signal indicator 402 to provide signal indication to the user. In some implementations, the display can include a user interface that allows the user to select a desired control of the temperature-setting element. For example, the user interface can turn on or off the heating/cooling component via functions displayed on the user interface. In some implementations, the user interface can be used to control the heating/cooling component to provide a desired temperature for the content in the portable device 100. In these implementations, the user interface can include a digital thermostat that can advantageously be adjusted to one of multiple temperature settings by the user to control the heating/cooling component in order to maintain its contents at a specified temperature or within a specified temperature range (e.g., via a “Up” GUI to increase the temperature and a “down” GUI to decrease the temperature).

In some implementations, the user interface can be used to set a timer for when power to the heating/cooling component is to be turned off, although the controller can also set a manufacturing setting that sets this time by default. The user interface could also include one or more power settings that can be set manually by the user. When set to a higher power setting, the heating/cooling component can run for a shorter period of time before the integrated power source 602 can no longer power the heating/cooling component. When set to a lower power setting, the heating/cooling component can be run for a longer period of time before the integrated power source 602 can no longer power the heating/cooling component. In some implementations, the temperature level can be selected by a user via an adjustable thermostat on the user interface.

### Temperature-Setting Element

As discussed above, the portable device 100 can include a temperature-setting element 107 configured to heat (or cool) the content of the housing to a particular temperature (e.g., 37° C./98.6° F. or another pre-determined temperature). In some implementations, the temperature-setting element 107 can include a heating component configured to heat the content to a temperature of about 97 degrees Fahrenheit to about 103 degrees (and vice versa). In some implementations, the temperature-setting element can also a cooling element to cool down the content below 97 degrees.

In some implementations, the temperature-setting element 107 can include a material configured to convert electrical energy into heat. In some implementations, the temperature-setting element 107 can include at least one of metal heating/cooling elements, ceramic heating/cooling elements, composite heating/cooling elements, or combination heating/cooling elements. In some implementations, the temperature-setting element 107 can include a metal heating/cooling component in the form of a wire, ribbon, or foil.

In some implementations, the temperature-setting element 107 can include a metallic resistance wire formed from at least one of nickel-chromium or copper-nickel. In some implementations, the temperature-setting element 107 can include a positive temperature coefficient ceramic material that becomes highly resistive above a composition-dependent threshold temperature. In some implementations, the portable device 100 can include a thermistor for self-regulating the temperature-setting element 107 (or can be regulated through the controller described herein). In some implementations, the temperature-setting element 107 can include components of an exothermic chemical reaction. In some embodiments, the temperature-setting element 107 can include a cooling component configured to cool the content of the portable device 100. In some implementations, the temperature-setting element 107 can include a thermoelectric cooling component (e.g., a Peltier device or thermoelectric cooler). In some implementations, the thermoelectric heating/cooling device can be configured for both heating and cooling the content inside the portable device 100.

The temperature-setting element 107 can be connected to the cap of the portable device 100. The inventors of the subject matter described herein have discovered that the total sum of both the mass of the removable temperature-setting element 107 and the heating mass surrounding the removable temperature-setting element 107 (e.g., the metal such as aluminum around the temperature-setting element) (collectively, “Total Mass”) has a direct correlation to the temperature overshoot factor. Specifically, it is discovered that the higher the Total Mass is, the longer it will take for the content to rise in temperature and the higher the overshoot temperature will be (and therefore the longer overshoot time and the temperature settling time). It is also discovered that the heat transfer energy is not directly used for heating the content; instead, the heat transfer energy must first be used to heat the Total Mass before being used to heat the content inside the portable device 100. After the power is turned off, the heat of Total Mass continues to heat the content, which results in the temperature overshoot.

In some implementations, the temperature-setting element 107 can include only a heating element. In some implementation, the temperature-setting element 107 can include a cooling component. In some implementations, the temperature-setting element 107 can include both a heating element and a cooling element.

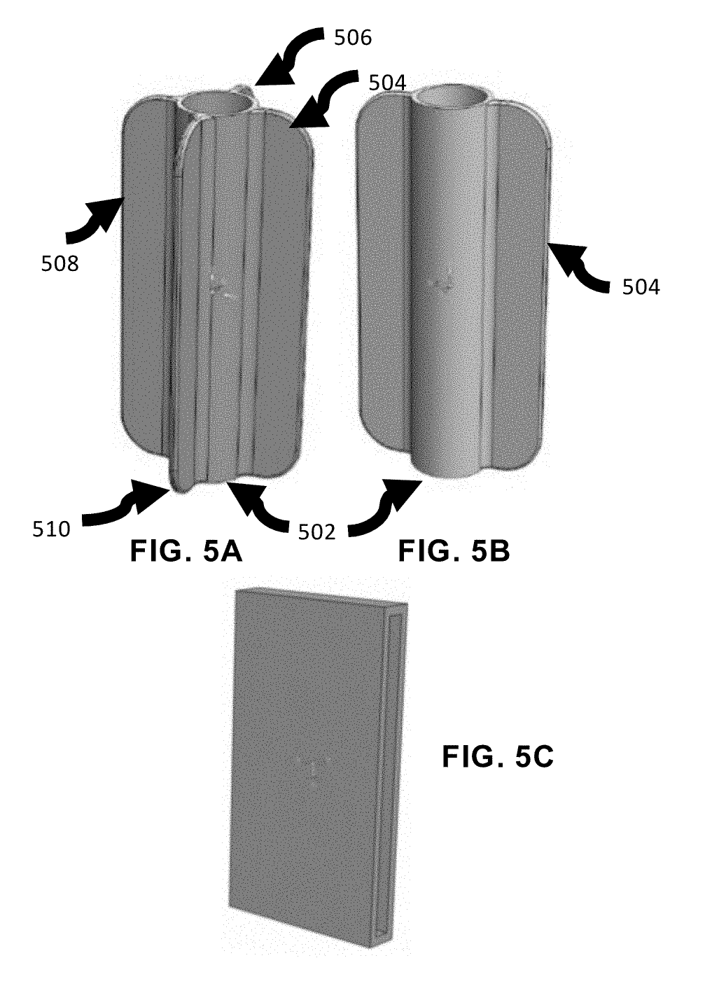

Referring to FIGS. 5A and 5B, the removable temperature-setting element 107 can include a core 502. The core 502 can be cylindrical shape that includes an inner circumferential wall and an outer circumferential wall. In some implementations, the inner circumferential wall of the core 502 contains a cavity. On the outer circumferential, the core 502 can include one or more flanges 504-510 that point outwardly. Any one of these flanges 504-510 can functions as a temperature-setting element, heat sink, or temperature sensor as previously described to provide enhanced heat dissipation function or temperature sensing capability to the portable device 100. In some implementations, flanges 504 and 510 can each function as a temperature sensing flange; flange 506 can function as a temperature setting flange; and flange 508 can function as a heat sink. In other implementations, flange 504 can function as a temperature sensing flange; flanges 506 and 510 can function as a temperature setting flange; and flange 508 can function as a heat sink. In yet other implementations, flange 504 can function as a temperature sensing flange; flange 506 can function as a temperature setting flange; and flanges 508 and 510 can each function as a heat sink. Although these implementations are described with respect to four flanges, as described above, there can be more or less than four flanges, with one or more flanges performing either one of temperature-setting, temperature sensing, or heat sink functions.

For example, such enhancement can be necessary in cases where the housing is made with different materials or has varying sizes that could affect the areas to be heated. Such adjustment, when warranted, can be effectuated by the controller in conjunction with the temperature-setting element, temperature sensor, or heat sink.

In some implementations, the number of flanges 504-510 can also be adjusted to counter the temperature overshoot. It is discovered that where the temperature-setting element 107 is rectangular shape (see, e.g., FIG. 5C), the heating mass is 5.2 cm³. When temperature-setting element 107 has a cylindrical core with the flange 506 protruding from the core 502, it is discovered that the volume of the heating mass is 7.4 cm³, which is 140% more than where the temperature-setting element 107 is rectangular shape. When temperature-setting element 107 has a cylindrical core with two flanges (e.g., flanges 506 and 510) protruding from the core 502, it is discovered that the volume of the heating mass is 5.1 cm³.

In some implementations, the temperature-setting element 107 can protrude from the cap (FIG. 2A) so that it can be exposed to the content while allowing the temperature-setting element 107 to be cleaned and maintained.

In some implementations, the temperature-setting element 107 can include a heater wire, heating wire, or a resistive heater. In some implementations, the temperature-setting element 107 can include an active cooling element or a passive cooling element. For example, where a passive cooling element is used, the temperature-setting element 107 can include a thermoelectric system with one or more Peltier elements. In some implementations, where the temperature-setting element 107 is an active cooling element, the temperature-setting element 107 can include a chilled fluid circulation system with channels in contact with, or in proximity to, the heating/cooling component.

In some implementations, the temperature-setting element 107 can include an internal thermocouple or a temperature sensor to sense and control the temperature of the content contained in the portable device 100. In some implementations, the internal thermocouple or temperature sensor can be positioned adjacent to the bottom of the core (see, e.g., FIG. 4B) and electrically connected to the temperature-setting element 107 to communicate a detected temperature to the controller such that the controller can adjust the temperature-setting element 107 to adjust the temperature if necessary. In some implementations, the thermocouple or temperature sensor may be a pressure sensor for sensing the pressure in the content. In addition to temperature, the temperature-setting element 107 can also detect humidity and pressure within the portable device 100.

One advantage provided by the portable device 100 is that it offers excellent and rapid heating or cooling of liquefied and non-liquefied content, and the temperature, humidity and pressure within the device can be controlled and regulated. The portability of the device 100 also allows for storage of content at a desired temperature, so that minimal time is wasted when preparing the bottle contents for human consumption. The portable device 100 can also allow for on-the-go heating (or cooling) of bottle contents to accommodate drinking needs while traveling.

### Energy Usage

In some implementations, the heating/cooling device can include an adjustable configuration that provides a range of temperature to which the contention in the heating device can be heated.

For example, in some implementations, the energy needed to heat the heating device at room temperature to 37° C./98.6° F. can be specified as c=Q/(m*ΔT) where “c” denotes the temperature of the content whose temperature is being maintained, “m” denotes the mass of the content, “ΔT” denotes the temperature difference, and “Q” denotes the energy in joules.

For example, to heat a 260 ml bottle containing milk from room temperature to 37° C./98.6° F., assuming that “c” is 3,930 J (kg*K), “m” is 260 ml×1.03 or 0.268 kg, room temperature is 20° C. or 68° F., and “ΔT” is 37° C. (or 98.6° F.)−20° C. (or 68° F.)=310K−293K=17K (degrees in Kelvin), the total amount of energy “Q” needed would be 17,905 joules (3,930 J/(kG 8 K)*0.268 kg*17K).

In this example calculation above, the volume of the removable temperature-setting element 107 itself (e.g., 23 ml) can also be taken into account. That is, the calculation can include the volume of the temperature-setting element. In some implementations, when the volume of the removable temperature-setting element 107 is included, (e.g., 260 ml-23 ml), the inventors have discovered that a faster heat up time can be achieved and less joule energy used.

Based on the foregoing, it would take time T=Q/P (where “T” denotes the time in seconds, “Q” denotes the amount of energy, and “P” denotes the power in watt) to heat the content in the heating/cool device. Using the foregoing example, if a 80 W temperature-setting element is used, it will take 17905 joules/80 (224 seconds or 3 minutes and 44 seconds) to complete the heating of the milk. In other words, the portable device, in some implementations, can completely heat the milk in no more than four minutes with enough charge capacity to do the same for two other bottles (i.e., for a total of 3 bottles with just one battery charge).

The forgoing example is only theoretical in nature. In practice, the inventors have discovered that using the same exemplary metrics above, it would take 4 minutes and 28 seconds to heat the milk (where the removable temperature-setting element 107 has a contact area of 55×30 mm and surface area of 16.5 cm² and where the milk consists of a mixture of milk powder and water using quantity recommended by the manufacturer of the milk powder). However, this time can be compensated and reduced back to under four minutes by using the flanges of the temperature-setting element as described herein.

In some cases, even where the power is turned off at 37° C./98.6° F., there is an overshoot in temperature up to 40.7° C./105.3° F. because of the residue heat energy emanating from the temperature-setting element. For this reason, and in some implementations, the temperature overshoot and settling time (e.g., time for the temperature to settle) can be considered in determining the amount of time necessary to reach a desired temperature. Using the previously given example and assuming that the final temperature will be held at 37° C./98.6° F., the inventors have discovered that it would take 3 minutes and 35 seconds to reach this final temperature, and require the power to be turned off at 34.5° C./94.1° F. Also, it would take 1 minute and 2 seconds of settling time for the milk to go from 34.5° C./94.1° F. to 37° C./98.6° F. Based on these discoveries, the portable device described herein is implemented with a temperature-setting element that can be configured to achieve these results.

A number of embodiments of the invention have been described. Nevertheless, it will be understood that various modifications can be made without departing from the spirit and scope of the invention. Accordingly, other embodiments are within the scope of the following claims.

Conditional language, such as, among others, “can”, “could”, “might”, or “can”, unless specifically stated otherwise, or otherwise understood within the context as used, is generally intended to convey that certain embodiments optionally could include, while some other embodiments do not include, certain features, elements and/or steps. Thus, such conditional language indicates, in general, that those features, elements and/or step are not required for every implementation or embodiment.

Various valuable aspects, benefits, capabilities, embodiments and/or features have been described above which are not available in the prior art. Further, these various aspects, benefits, capabilities, embodiments and/or features can be used independently or in combination, as appropriate to achieve a desired result; it is not necessary to incorporate every aspect, benefit, capability, embodiment and/or feature into a single implementation in order to obtain specific desired aspects, benefits, capabilities, and/or features.

What is claimed is:

1. A portable device comprising:
a cap including an integrated power source for supplying power;
a housing including a storage for storing content, the housing releasably secured to the cap;
a temperature sensor for detecting temperature of the content; and
a temperature-setting element for setting the temperature of the content, the temperature-setting element including a core,
wherein:
the integrated power source is configured to supply the power to the temperature sensor and the temperature-sensing element;
the temperature-setting element is configured to set the temperature at a predetermined temperature; and
the temperature sensor and the temperature-setting element are secured to the cap.

2. The portable device of claim 1, further comprising one or more flanges, each protruding from the core and pointedly outwardly, wherein at least one flange is configured to detect the temperature of the content, to set the temperature of the content, or to dissipate heat away from the core.

3. The portable device of claim 1, further comprising a plurality of flanges, each protruding from the core and pointedly outwardly, wherein the plurality of flanges includes one flange configured to detect the temperature of the content, one flange configured to set the temperature of the content, and one is configured to dissipate heat away from the core.

4. The portable device of claim 1, further comprising a plurality of flanges, each flange configured to function as a heat sink to dissipate heat away from the temperature-setting element.

5. The portable device of claim 4, wherein the plurality of flanges have the same shape.

6. The portable device of claim 1, further comprising a controller configured to control the temperature-setting element to set the temperature at the predetermined temperature.

7. The portable device of claim 6, wherein the controller is configured to control the temperature-setting element to set the temperature at the predetermined temperature based on the detected temperature of the content.

8. The portable device of claim 1, wherein the temperature sensor is secured to the temperature-setting element and the temperature-setting element is secured to the cap using a locking mechanism.

9. The portable device of claim 8, further comprising a release mechanism configured to release the temperature-setting element from the cap when the release mechanism is activated.

10. The portable device of claim 1, further comprising a switch configured to activate the temperature-setting element by a user, wherein the switch is located on or integrated with the cap.

11. The portable device of claim 1, further comprising a power receiver configured to electrically connect with an external power source for charging the integrated power source.

12. The portable device of claim 1, further comprising a display for displaying information selecting from a list comprising a time elapsed since the temperature was last set, an amount of power remaining in the integrated power source, and a number of times that the portable device is used to set the temperature at the predetermined temperature without being charged.

13. The portable device of claim 1, wherein the a temperature-setting element is configured to heat the content until the temperature of the content is at room temperature.

14. A portable device comprising:
a cap including an integrated power source configured to supply power;
a housing including a storage for storing milk, the housing releasably secured to the cap;
a temperature sensor configured to detect temperature of the milk;
a heating element configured to heat the milk at a predetermined temperature, the heating element including a core, the core including one or more flanges each protruding from the core, each flange configured to function as a heat sink to dissipate heat away from the portable device;
a securing mechanism configured to secure the temperature sensor and the heating element to the cap; and
a release mechanism configured to release the temperature sensor and the heating element from the cap when the release mechanism is activated,
wherein:
the integrated power source is configured to supply the power to the temperature sensor and the heating element; and
the temperature sensor and the heating element are secured to the cap.

15. The portable device of claim 14, wherein the core includes four flanges.

16. The portable device of claim 15, wherein the four flanges have the same shape.

17. The portable device of claim 14, further comprising a controller configured to control the heating element to heat the content at the predetermined temperature.

18. The portable device of claim 17, wherein the controller is configured to control the heating element based on the detected temperature of the content.

19. The portable device of claim 14, wherein the heating element is secured to the cap using a locking mechanism.

20. The portable device of claim 19, further comprising a release mechanism configured to release the heating element from the cap when the release mechanism is activated.
